(19) United States
(12) Patent Application Publication
(10) Pub. No.: US 2009/0154967 A1
(43) Pub. Date: Jun. 18, 2009

(54) Fuser device and image forming device

(75) Inventor: Kunihiko Tomita, Yokohama-shi (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/314,836

(22) Filed: Dec. 17, 2008

(30) Foreign Application Priority Data
Dec. 18, 2007 (JP) 2007-326346

(51) Int. Cl. G03G 15/20

(52) U.S. Cl. 399/333

(57) ABSTRACT

A fuser device includes a fusing member including an elastic layer on a surface side thereof and a cylindrical curved surface portion having a predetermined diameter, a heating member including a cylindrical curved surface portion having a predetermined diameter, the heating member having contact with the fusing member and heating the fusing member, and a pressure member including an elastic layer on a surface side thereof and a cylindrical curved surface portion having a predetermined diameter, the pressure member pressing the fusing member.

### PRIORITY CLAIM

The present application is based on and claims priority from Japanese Patent Application No. 2007-326346, filed on Dec. 18, 2007, the disclosure of which is hereby incorporated by reference in its entirety.

### BACKGROUND OF THE INVENTION

1. Field of the Invention

The present invention relates to a fuser device and an image forming device including the fuser device.

2. Description of the Related Art

An electrophotographic device which forms an image by using toners is used as an image forming device such as a copier, a facsimile or a printer. This image forming device includes a fuser device which fuses a toner image transferred onto a recording medium such as one sheet of recording paper by heating and pressurizing the recording paper.

Recently, there has been a growing demand for resource saving and energy saving for protecting the environment. This demand is not exceptional in an image forming device having an electrophotographic method. Research and development for saving resources and energy is activated especially in the fusing field, which has the largest energy consumption.

In a fuser device which is provided in an image forming device and fuses toners by heating and pressuring processes, toners are fused at a considerably-high temperature compared to a normal temperature. Since the fuser device has a predetermined heat capacity and requires a predetermined time to reach a required temperature, the fuser device must be preheated while the fuser device is not used. For this reason, the power consumed by the preheating increases the power consumption of the entire device.

Consequently, a technique is proposed which instantly increases a temperature of a fusing face of the fuser device from a cold state by means of an electromagnetic induction device or shortens a heating-up time by increasing initial power by means of a capacitor, so as to reduce energy consumption.

JP4047209B describes a fuser device, in order to appropriately measure and control a temperature for fusing toners, including a non-contact probe which is provided separately from a fusing roller and measures a temperature of the fusing roller, a contact probe which is disposed to have contact with a pressure roller and measures a temperature of the pressure roller, and a controller which controls the power distribution to a heat source such that a temperature measured by the non-contact probe becomes a first target temperature, controls the power distribution to a heat source such that a temperature measured by the contact probe becomes a second target temperature, controls the rotation of the fusing roller and the pressure roller, and determines that the non-contact probe has an error when the temperature measured by the contact probe is the first target temperature or more.

JP3902565B describes a fuser device which fuses an unfused image by passing a recording medium including the unfused image through a nip section formed by a rotation member and a facing member, so as to smoothly increase a temperature of a fusing member and maintain a surface temperature of the fusing member without increasing a risk of firing. Such a fuser device includes a heating member for heating a surface of the rotation member by the contact to the surface of the rotation member, and a structure in which the rotation member has a convex shape and the heating member is deformable into a concave shape corresponding to the convex shape by the contact of the rotation member.

JP H09-54510A describes a fuser device including a heating roller which heats a sheet to which developed toners are adhered, a pressure roller which feeds the sheet while sandwiching the sheet with the heating roller, and a surface heating device which is disposed near the outer circumference face of the heating roller and heats the surface of the heating roller, so as to directly heat a thermocompression layer forming the surface of the heating roller.

In the meanwhile, color images are becoming the mainstream of recent image output. An image forming device is required to provide high quality and high stability for not only a black-and-white image but also a color image. Especially, the condition of the toner surface fused on a recording medium is important, and high quality is required relative to appropriate brilliance and uneven brilliance resistance. Since brilliance of a color image is set higher than that of a black-and-white image, an adhesion degree of a fusing face of a fuser device with toners is high, and a winding strength of toners to the fusing face is easily increased, which require improvements.

### SUMMARY OF THE INVENTION

It is, therefore, an object of the present invention to provide a fuser device and an image forming device which can reduce a time for increasing a temperature while saving power, and obtain a high quality image.

In order to achieve the above object, a first aspect of the present invention relates to a fuser device including a fusing member including an elastic layer on a surface side thereof and a cylindrical curved surface portion having a predetermined diameter, a heating member including a cylindrical curved surface portion having a predetermined diameter, the heating member having contact with the fusing member and heating the fusing member, and a pressure member including an elastic layer on a surface side thereof and a cylindrical curved surface portion having a predetermined diameter, the pressure member pressing the fusing member, wherein the fusing member and the pressure member sandwich a recording medium having an unfused toner image so as to fuse the unfused toner image, a surface temperature of the heating member is set higher than a setting temperature of the fusing member without disposing a heat generation source inside the fusing member, the diameter of the cylindrical curved surface portion of the fusing member is smaller than the diameter of the cylindrical curved surface portion of the heating member, and the diameter of the cylindrical curved surface portion of the pressure member is the diameter of the cylindrical curved surface portion of the fusing member or more.

Preferably, the fusing member includes a metallic innermost layer, the elastic layer outside the innermost layer, and a fluorinated protection layer outside the elastic layer.

Preferably, the elastic layer is made of a solid rubber having a heat-resistant property or a sponge having a heat-resistant property.

Preferably, the heating member is made of a metal.

Preferably, the heating member includes on a surface thereof a fluorinated resin layer.

Preferably, the pressure member has inside thereof a heat generation source.

Preferably, the pressure member includes a metallic innermost layer, a rubber layer outside the innermost layer, and a fluorinated protection layer outside the rubber layer.

Preferably, the rubber layer is a solid rubber.

Preferably, the heating member includes a setting temperature in a heating-up period, which is set 10 degrees higher than a setting temperature of the heating member in a standby period.

Preferably, the heating member has a setting temperature just before passing the recording medium higher than the setting temperature in the standby period.

Preferably, the pressure member has a setting temperature which is set lower than a setting temperature of the fusing member.

Preferably, the fusing member includes a metallic innermost layer, the elastic layer outside the innermost layer, and a fluorinated protection layer outside the elastic layer, the elastic layer includes a sponge layer and a solid layer outside the sponge layer, and a thickness of the sponge layer is larger than a thickness of a solid rubber layer.

Preferably, the fusing member is a cylindrical fusing roller or an endless fusing belt.

Preferably, the heating member is a cylindrical heating roller or an endless heating belt.

Preferably, the pressure member is a cylindrical pressure roller or an endless pressure belt.

Preferably, the heating member has a heat generation source made of a halogen lamp or a lamp into which noble gas is filled, and the pressure member has a heat generation source made of a halogen lamp or a lamp into which noble gas is filled.

A second aspect of the present invention relates to an image forming device having the above-described fuser device.

### BRIEF DESCRIPTION OF THE DRAWINGS

The accompanying drawings are included to provide further understanding of the invention, and are incorporated in and constitute a part of this specification. The drawings illustrate embodiments of the invention and, together with the specification, serve to explain the principle of the invention.

FIG. 1 provides a sectional view schematically illustrating an image forming device according to an embodiment of the present invention.

FIG. 2 provides a sectional view illustrating a schematic structure of a fuser device according to an embodiment of the present invention.

FIG. 3A provides a sectional view illustrating a schematic structure of a fusing roller according to an embodiment of the present invention.

FIG. 3B provides a sectional view illustrating a schematic structure of a fusing roller according to a modified example of the present invention.

FIG. 4A provides a sectional view illustrating a schematic structure of a heating roller according to the embodiment of the present invention.

FIG. 4B provides a sectional view illustrating a schematic structure of a heating roller according to the modified example of the present invention.

FIG. 5 provides a sectional view illustrating a schematic structure of a pressure roller.

FIG. 6 provides a sectional view schematically illustrating a fuser device according to a second embodiment of the present invention.

FIG. 7 provides a sectional view schematically illustrating a fuser device according to a modified example of the second embodiment of the present invention.

FIG. 8 provides a sectional view schematically illustrating a fuser device according to another modified example of the second embodiment of the present invention.

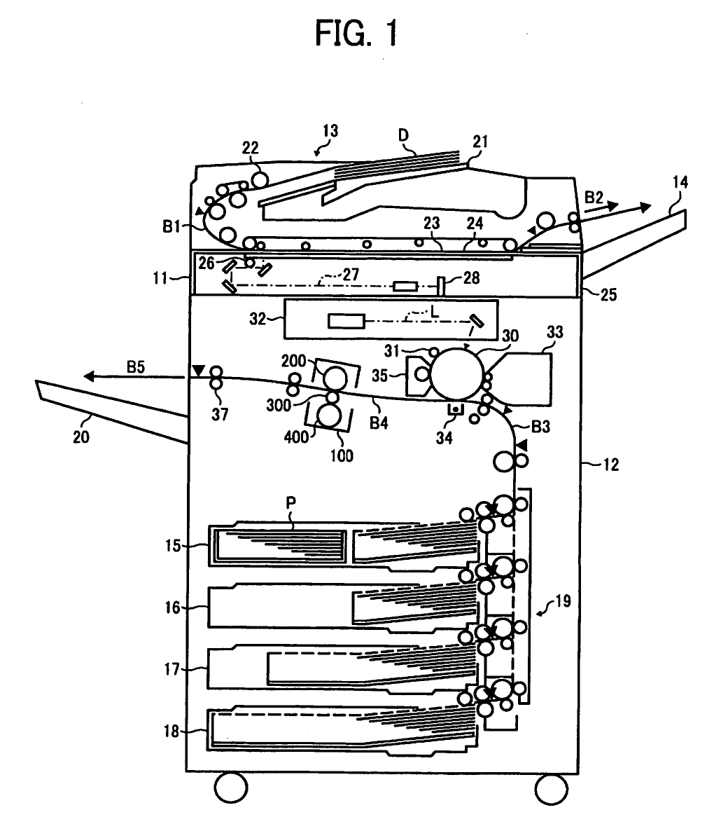

### DETAILED DESCRIPTION OF THE PREFERRED EMBODIMENTS

Hereinafter, an embodiment of the present invention will be described with reference to the accompanying drawings. In addition, the embodiment of the present invention relates to a fuser device and an image forming device, especially to a fuser device having a fusing member, which includes an elastic layer on a surface side thereof and a cylindrical curved surface portion having a predetermined diameter, a heating member, which has contact with the fusing member, so as to heat the fusing member, and includes an elastic layer on surface side thereof and a cylindrical curved surface portion having a predetermined diameter, and a pressure member, which presses the fusing member, the fuser device conducting fusing by sandwiching a recording medium having an unfused toner image between the fusing member and the pressure member, and also an image forming device having the fuser device. An image forming device according to the embodiment of the present invention includes an original document reading unit 11, an image forming unit 12 which forms an image, an automatic document feeder (ADF) 13, a tray 14 which stacks original documents fed from the ADF 13, a paper feeding unit 19 having paper feeding cassettes 15-18, and a discharged paper unit (discharged paper tray 20) which stacks recording paper.

In this image forming device, if a print key is pressed, for example, by the operation of an operation unit (not shown) in a state in which original documents D are set on a platen 21 of the ADF13, the top original document D is fed in the direction of the arrow B1 by the rotation of a pick-up roller 22, and then is placed on a contact glass 24 fastened to the reading unit 11 by the rotation of an original document feeding belt 23. The image of the placed original document D is read by a reading device 25 placed between the image forming unit 12 and the contact glass 24. The reading unit 25 includes a light source 26 which illuminates the original document D on the contact glass 24, an optical system 27 which focuses the image of the original document, and a photoelectric conversion element 28 such as a CCD, which focuses the image of the original document. After reading the image, the original document D is fed to the arrow B2 direction by the rotation of the original feeding belt 23 and is discharged on the tray 14. As described above, the original document D is fed onto the contact glass 24 one by one, and the image of the original document is read by the reading unit 11.

The image forming unit 12 includes inside thereof a photoconductor 30 of an image carrier. The photoconductor 30 rotates in the clockwise direction in the figure, and has a surface which is charged to a predetermined potential by a charging unit 31. The charged surface of the photoconductor 30 is irradiated from a writing unit 32 by laser light L modulated according to the image information read by the reading device 25, and is exposed by this laser light L. An electrostatic latent image is thereby formed on the surface of the photoconductor 30. This electrostatic latent image is transferred onto the recording paper P of recording media fed between a transfer unit 34 and the photoconductor 30 by the transfer unit 34 when passing through a development unit 33. The surface of the photoconductor 30 after the toner image is transferred is cleaned by a cleaning unit 35.

The recording paper P is housed in each of the paper feeding cassettes 15-18 disposed in the lower portion of the image forming section 12. One sheet of the recording paper P is fed from any one of the paper feeding cassettes 15-18 in the arrow B3 direction, and the toner image formed on the surface of the photoconductor 30 is transferred on the surface of the recording paper P. Next, the recording paper P passes through a fuser device 100 in the image forming unit 12 as illustrated by the arrow B4, and the toner image transferred onto the surface of the recording paper P is fused by the functions of heating and pressuring. The recording paper P, which has passed through the fuser device 100, is fed by a pair of discharge rollers 37, and is discharged and stacked on the discharged paper tray 20 as illustrated by the arrow B5.

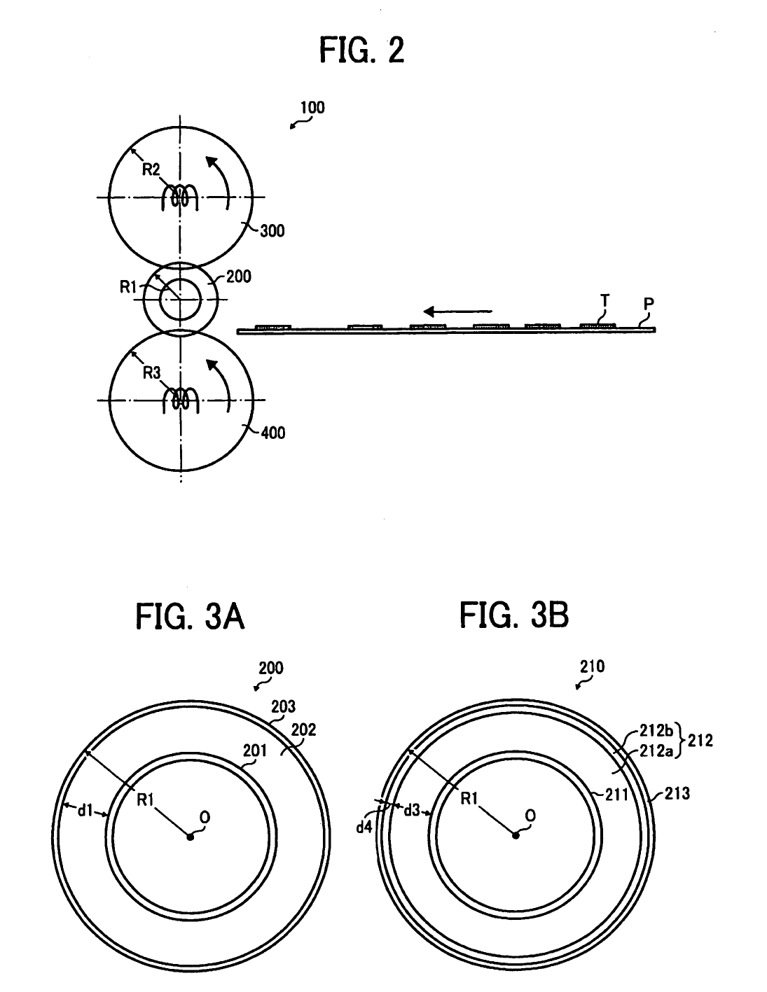

Next, the fuser device 100 of the image forming device according to the embodiment of the present invention will be described with reference to FIG. 2. In this embodiment, the fuser device 100 fuses unfused toners T carried on the recording paper P by heating. The fuser device 100 includes a fusing roller 200 as a fusing unit, a heating roller 300 as a heating unit, and a pressure roller 400 as a pressure unit. The heating roller 300 is a cylindrical hollow member having inside thereof a heater 301 as a heat source. The pressure roller 400 is a cylindrical hollow member having inside thereof a heater 401 as a heat source. In this embodiment, a heat source is not provided in the fusing roller 200. The fusing device 100 according to this embodiment has the following features. More particularly, the fusing roller 200 does not have inside thereof a heat generation source. The temperature of the fusing roller 200 increases by the contact of the heating roller 300 to the surface of the fusing roller 200. As the heaters 301, 401, a halogen lamp or a lamp into which noble gas is filled can be used.

First, the fusing rollers 200, 210 according to the embodiment and the modified example of the present invention will be described referring to FIGS. 2A, 2B. As illustrated in FIG. 3A, the fusing roller 200 according to the embodiment of the present invention includes a metallic tubular body 201, an elastic layer 202 outside the tubular body 201, and a fluorinated protection layer 203 outside the elastic layer 202. The fusing roller 200 has a radius R1 and the elastic layer 202 has a thickness d1.

As illustrated in FIG. 3B, the fusing roller 210 according to the modified embodiment includes a metallic tubular body 211, a sponge layer 212a and a solid rubber layer 212b as an elastic layer 212 outside the tubular body 211, and a fluorinated protection layer 213 outside the elastic layer 212. In this example, a thickness d3 of the sponge layer 212a is larger than a thickness d4 of the solid rubber layer 212.

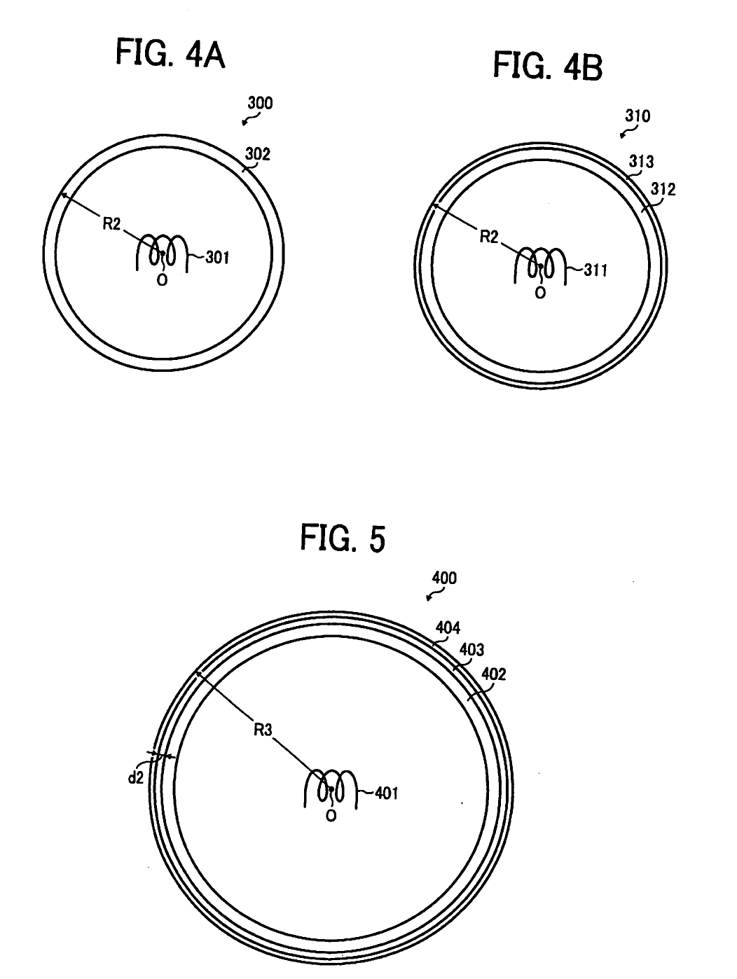

Next, the heating rollers 300, 310 according to the embodiment and the modified example of the present invention will be described with reference to the FIGS. 4A, 4B. As illustrated in FIG. 4A, the heating roller 300 according to the embodiment of the present invention includes a metallic tubular body 302 having a heater 301 inside thereof. The heating roller 300 includes a radius R2.

As illustrated in FIG. 4B, the heating roller 310 according to the modified example includes a metallic tubular body 312 having a heater 311 inside thereof, and a fluorinated protection layer 313 disposed in the outer circumference of the tubular body 312.

Next, the pressure roller 400 will be described with reference to FIG. 5. The pressure roller 400 includes a metallic tubular body 402 having a heater 401 inside thereof, an elastic layer 403 outside the tubular body 402, and a fluorinated protection layer 404 outside the elastic layer 403.

In the above-described fuser device 100, each of the fusing rollers 200, 210 has a cylindrical curved surface portion, and each of the heating rollers 300, 310 has a cylindrical curved surface portion. The radius R1 of the cylindrical curved surface portion of each fusing roller 200, 210 is smaller than the radius R2 of the cylindrical curved surface portion of each heating roller 300, 310. In addition, the radius R3 of the pressure roller 400 is the radius R1 of the fusing roller 200 or more.

The thickness d1 of each elastic layer 202, 212 of each fusing roller 200, 210 is larger than the thickness d2 of the elastic layer 403 of the pressure roller 400.

In the fuser device 100 according to the embodiment of the present invention, the fusing rollers 200, 210, the heating rollers 300, 310 and the pressure rollers 400 according to the embodiment and the modified example can be appropriately combined.

Next, the fuser device according to the embodiment of the present invention will be described. In the fuser device 100 according to the embodiment of the present invention, energy to be applied is effectively utilized, so as to increase the temperature of the fusing roller and the surface of the belt. The fusing roller 200 generally has a large diameter for ensuring a width of a nip portion between the fusing roller 200 and the pressure roller 400, and also includes a rubber layer on the surface thereof for ensuring the width of the nip portion by the compression deformation of the rubber layer. However, if the thickness of the rubber layer is increased, the temperature of the fusing roller can not be increased because of the thickness. For this reason, the thickness of the rubber layer can not be increased. Accordingly, in order to ensure the width of the nip portion, the diameter of the fusing roller 200 has to be increased. However, if the diameter of the fusing roller is increased, the heat capacity of the fusing roller is increased. For this reason, it takes a long time to increase the temperature of the fusing roller.

In this embodiment, in order to decrease the mass and the surface area to be heated of the fusing roller 200, the radius R1 of the fusing roller 200 is set to be smaller than the radius R2 of the heating roller 300. In the meanwhile, the width of the nip portion is ensured by increasing the thickness of the elastic layer 202. In this embodiment, even if the elastic layer 202 having low heat conductivity is provided in the fusing roller 200, the energy can be focused on the heating to the surface because the fusing roller 200 does not have inside thereof a heat generation source so as to eliminate a causal connection with the heating-up period.

Moreover, since the heating roller 300 pressed to the fusing roller 200 in which its temperature is lowered in the heating-up period is cooled at the nip portion, and the temperature of the surface of the heating roller 300 is instantly decreased, the fusing roller 200 has a sufficient time for receiving the heat from the heater 301 of the heating roller 300 so as to have a time for recovering a temperature. Furthermore, in order to have the width of the nip portion as long as possible relative to the small diameter fusing roller 200, the thickness of the elastic layer 202 of the fusing roller is increased, and also the radius R3 of the pressure roller 400 is set to be larger than the radius R1 of the fusing roller 200. The width of the nip portion is thereby ensured.

For this reason, in the fuser device 100 of this embodiment, the radius R1 of the fusing roller 200 is smaller than the radius R2 of the heating roller 300, and the radius R3 of the pressure roller 400 is set to be the radius R2 of the fusing roller 200 or more. The thickness d1 of the elastic layer 202 of the fusing roller 200 is larger than the thickness d2 of the elastic layer 403 of the pressure roller 400.

The fusing roller 200 of this embodiment has the metallic tubular body 201 so as to have a sufficient strength, the elastic layer 202 so as to ensure the width of the nip portion of fusing by the compression and deformation of the elastic layer 202, and the fluorinated protection layer so as to maintain a releasing property to the toners.

The elastic layer 202 can be made of heat-stable solid rubber or sponge. It is especially preferable to use a silicone rubber as the material of the elastic layer 202. A metal type of the tubular body 201 of the fusing roller 200 is not limited, and any type of metal can be used. An alloy can be used as the material of the tubular body 201.

It is preferable for the thickness of the elastic layer 202 to be 1 mm or more, more preferably to be 2 mm or more, further preferably to be 3 mm or more, still further preferably to be 5 mm or more, and the most preferably to be 7 mm or more. If the strength and the outer diameter of the fusing roller allow, it is preferable for the elastic layer to be made as thick as possible.

It is necessary for the heating roller 300 to be made of a metal so as to transfer heat to the fusing roller. As described in the modified example, the surface of the heating roller 310 can be prevented from being contaminated by disposing the fluorinated resin layer on the surface of the heating roller 310. However, it is preferable for the fluorinated resin layer to be made as thin as possible because it easily becomes a barrier which blocks heat conduction.

It is preferable for the thickness of the fluorinated resin layer to be 0.05 mm or less, more preferably to be 0.03 mm or less, and further preferably to be 0.01 mm or less.

Since the fusing roller 200 of this embodiment does not have inside thereof a heat generation source, the heat of the surface is removed by recording paper having a low temperature after the recording paper passes through the roller. If the heat capacity and the temperature of the recording paper are constant, the heat of the surface of the fusing roller 200 can not be removed by setting the surface temperature of the fusing roller in accordance to the temperature of the recording paper. However, the heat capacity and the temperature of the recording paper are not always constant, and the temperature of the recording paper is significantly decreased in winter.

In order to obtain a stable fusing performance in such a situation, the heater 401 as a heat generation source is disposed inside the pressure roller 400 so as to maintain a constant surface temperature of the heating roller 300 as much as possible and to correspond to the change in the condition of the recording paper. The pressure roller 400 includes, in order from the innermost layer, the tubular body 402, the elastic layer 403 and the fluorinated protection layer 404. Therefore, even if the heater 401 is disposed inside the tubular body 402, the burning of the inner face can be prevented because the metallic tubular body 402 is disposed just outside the heater 401. It is preferable for the thickness of the elastic layer 403 disposed on the tubular body 402 to be thin because the heat can be easily transferred to the surface of the pressure roller 400. It is preferable for the thickness of the pressure roller 400 to be less than 1 mm, more preferably to be 0.5 mm or less, and further preferably to be 0.2 mm or less.

It is also preferable for the thickness of the fluorinated protection layer 404 formed on the elastic layer 403 to be thin. It is preferable for the thickness of the fluorinated protection layer 404 to be 0.05 mm or less, more preferably to be 0.03 mm or less, and further preferably to be 0.1 mm or less. It is preferable to use a solid rubber having high heat conductivity as the elastic layer 403, and a sponge having low heat conductivity can not be used.

In this embodiment, the temperature of the heating roller 300 in the heating-up period is set to be 10 degrees or more higher than the temperature of the heating roller 300 in the standby period. Thereby, the heat grade can be increased, and the heat can be significantly transferred to the fusing roller 200. It is preferable for a difference between the setting temperature of the standby and the setting temperature of the heating-up period to be set as large as possible.

It is preferable for the difference to be 20 degrees or more, more preferably to be 30 degrees or more, and further preferably to be 50 degrees or more.

It is preferable to increase the setting temperature of the heating roller 300 higher than the setting temperature of the heating roller 300 in the standby period just before the passing of the recording paper. By increasing the heat grade, the surface temperature of the fusing roller 200 can be maintained in the standby period. Since the recording paper significantly takes the heat of the fusing roller 200 when the recording paper passes, the heat taken by the recording paper can be covered. It is also necessary for the setting temperature of the pressure roller 400 to be the same as the setting temperature of the fusing roller or to be lower than the setting temperature of the fusing roller. As described above, since the recording paper significantly takes the heat from the fusing roller when the recording paper passes through the roller, the conditional change can be covered by setting the setting temperature of the pressure roller 400 as described above. Since the recording paper is not fused from the back face thereof, it is not necessary to set the setting temperature of the pressure roller to be larger than the setting temperature of the fusing roller 200. However, it is necessary to set the setting temperature of the pressure roller within a range of −70 degrees of the temperature of the fusing roller, more preferably within a range of −50 degrees of the temperature of the fusing roller, further preferably within a range of −30 degrees of the temperature of the fusing roller, and still further preferably within a range of −10 degrees of the temperature of the fusing roller.

The fusing roller 210 according to the modified example includes, in order from the innermost layer, the metallic tubular body 211, and the elastic layer 212 having the sponge layer 212a and the solid rubber layer 212b. The thickness of the sponge layer 212a is larger than the thickness of the solid rubber layer 212b.

The elastic layer 212 is divided into two layers, the sponge layer 212a and the solid rubber layer 212b. If the elastic layer 212 is made of only the sponge layer 212a, when the recording paper enters into the nip portion, the pressure may be released at the aerocyst spots of the sponge layer 212a. For this reason, the heat capacity of the sponge layer 212a becomes too small because the density of the sponge layer 212a is low, and the surface temperature is significantly decreased when nipping the recording paper, resulting in a fusing error. Accordingly, the elastic layer 212 has the two layers in order to prevent the above-described error.

Even if the sponge layer 212a is used, the releasing of the pressure can be prevented by the drag of the solid rubber layer 212b if the solid rubber layer 212b is provided outside the sponge layer 212a. The solid rubber has a heat capacity larger than that of the sponge, so that an extreme decrease in a temperature can be prevented. On the other hand, if the solid rubber is only used, the heat capacity becomes too big, so that the heating-up period is increased. It is preferable for the thickness of the sponge layer to be 1 mm or more, more preferably to be 2 mm or more, and further preferably to be 5 mm or more. It is preferable for the thickness of the rubber layer to be 0.01-0.5 mm, and more preferably to be 0.1-0.2 mm.

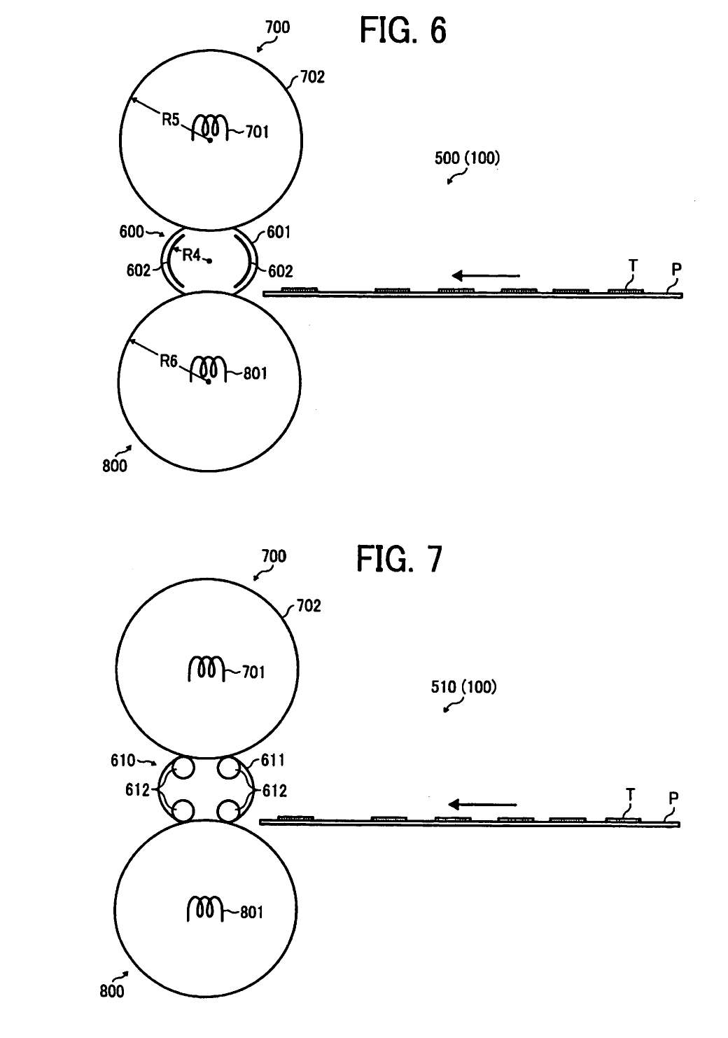

Next, a fuser device according to a second embodiment of the present invention will be described with reference to FIG. 6. In this embodiment, the fuser device includes an endless belt member as a fusing member.

In this embodiment, a fuser device 500 includes a fusing belt device 600 as a fusing member, a heating roller 700 as a heating member, and a pressure roller 800 as a pressure member.

The fusing belt device 600 includes an endless fusing belt 601 and two arc belt guides 602 disposed inside the fusing belt 601. The fusing belt 601 is maintained in a cylindrical shape having a radius R4, and has contact with the surface of the heating roller 700 and the surface of the pressure roller 800 by the belt guides 602. The fusing belt 601 is made of an endless metallic belt having on the surface thereof an elastic layer and a fluorinated protection layer. The unfused toners T carried on the recording sheet P are fused at the nip portion formed between the pressure roller 800 and the fusing belt device 600.

The heating roller 700 includes a structure similar to that in the heating rollers 300, 310 of the above-described first embodiment. The heating roller 700 has inside thereof a heater 701 such as a halogen lamp. The pressure roller 800 includes a structure similar to that of the pressure roller 400 in the first embodiment, and has inside thereof a heater 801 such as a halogen lamp.

In this embodiment, the radius R4 of the fusing belt device 600 is smaller than the radius R5 of the heating roller 700. The radius R6 of the pressure roller 800 is set to be the radius R1 of the fusing belt 601 or more. The fusing belt 601 is provided with an elastic layer, and the pressure roller 800 is provided with an elastic layer. The thickness of the elastic layer of the fusing belt 601 is larger than the thickness of the elastic layer of the pressure roller 800.

In the fusing device 500 according to this embodiment, the temperature of the fusing member can be increased in a short time, and the fusing performance of a high image quality can be obtained, similar to the fusing device 100 in the first embodiment.

According to a modified example of the second embodiment, a fusing device 510 illustrated in FIG. 7 includes a fusing belt device 610 as a fusing member, a heating roller 700 as a heating member, and a pressure roller 800 as a pressure member. The fusing belt device 610 includes a fusing belt 611 and four guide rollers 612 as guide belts for supporting the fusing belt 611 in a cylindrical shape. The fusing belt 611 is made of a metallic endless belt on which an elastic layer and a fluorinated protection layer are formed. The heating roller 700 and the pressure roller 800 have a structure similar to that of the fusing device 500 illustrated in FIG. 6.

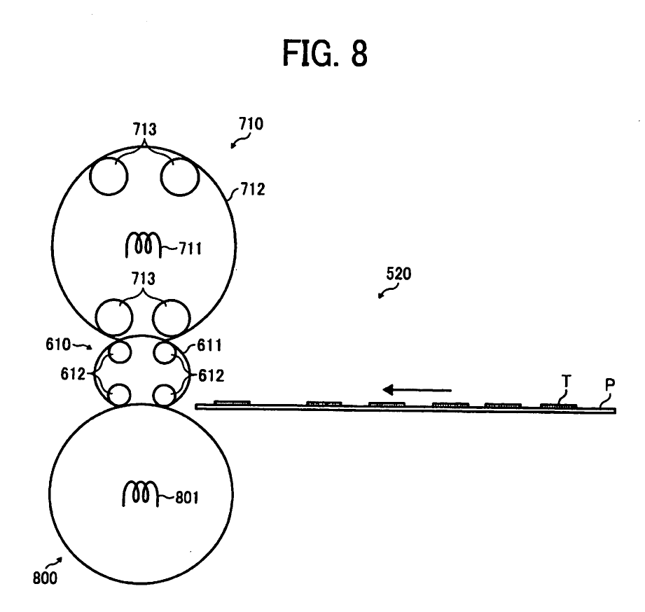

Next, a fuser device according to another modified example of the second embodiment will be described with reference to FIG. 8. A fuser device 520 as illustrated in FIG. 8 includes a fusing belt device 610 as a fusing member, a heating belt device 710 as a heating member, and a pressure roller 800 as a pressure member. The heating belt device 710 has inside thereof a heater 711. The heating roller 700 includes a metallic endless pressure belt 712 and four guide rollers 713 for supporting the pressure belt 712 in a cylindrical shape. The heating belt 710 includes a fluorinated protection layer. The fusing belt device 610 and the pressure roller 800 have a structure similar to that of the fuser device 510 illustrated in FIG. 7.

### Embodiment

Hereinafter, embodiments of fuser devices will be described according to experiments conducted by the present inventors.

### Embodiment 1

(Structure) The experiment was conducted under the following conditions in the structure illustrated in FIG. 2.

Pressure roller (made of aluminum t=0.6, Ø40)

Fusing roller (made of sponge layer t=4, PFA tube t=0.03)

Pressure roller (made of aluminum t=0.6, Ø40, rubber layer t=0.2, PFA tube t=0.03)

Heater of heating roller (halogen 900 W)

Heater of pressure roller (halogen 300 W)

In this case, the setting temperature of the heating roller was 200° C.

### (Result)

The heating-up period to 150° C. was 35 sec.

In the paper pasting experiment, recording paper was separated in a direction away from the fusing face.

The heating roller was slightly contaminated by toners at 100000 sheets of paper.

### (Comparative 1)

### (Structure)

Fusing roller (aluminum cored bar t=0.6, rubber layer t=2, PFA tube t=0.03)

Pressure roller (Ø40, rubber layer t=4, PFA tube t=0.03)

Heater of fusing roller (halogen heater 1200 W)

### (Result)

The heating-up period to 150° C. was 240 sec.

In the paper passing experiment, the recording paper was separated in a direction winding to the fusing face.

### (Comparative 2)

### (Structure)

Fusing roller (aluminum cored bar t=0.6, rubber layer t=4, PFA tube t=0.03)

Pressure roller (Ø40, rubber layer t=2, PFA tube t=0.03)

Heater of fusing roller (halogen heater 1200 W)

### (Result)

The heating-up period to 150° C. was 480 sec.

In the paper passing experiment, the recording paper was separated in a direction away from the fusing face.

### Embodiment 2

### (Structure)

An experiment was conducted under the following conditions in the structure illustrated in FIG. 2.

Heating belt (made of aluminum t=0.1, Ø40)

Fusing roller (sponge layer t=4, PFA tube t=0.03)

Pressure belt (made of aluminum t=0.6, Ø40, rubber layer t=0.2, PFA tube t=0.03)

Heater of heating belt (halogen heater 900 W)

Heater of pressure belt (halogen heater 300 W)

In this case, the setting temperature of the heating belt was 200° C.

### (Result)

The heating-up period of the surface of the fusing roller to 150° C. was 25 sec.

In the paper passing experiment, the recording paper was separated in a direction away from the fusing face.

### Embodiment 3

### (Structure)

An experiment was conducted under the following conditions in the structure illustrated in FIG. 2.

Heating roller (made of aluminum t=0.6, Ø40, surface layer PFA coating t=0.03)

Fusing roller (sponge layer t=4, PFA tube t=0.03)

Pressure roller (made of aluminum t=0.6, Ø40, rubber layer t=0.2, PFA tube t=0.03)

Heater of heating roller (halogen heater 900 W)

Heater of pressure roller (halogen heater 300 W)

In this case, the setting temperature of the heating roller was 200° C.

### (Result)

The heating-up period to 150° C. was 45 sec.

In the paper passing experiment, the recording paper was separated in a direction away from the fusing face.

### Embodiment 4

### (Structure)

An experiment was conducted under the following conditions in the structure illustrated in FIG. 2.

Heating roller (made of aluminum t=0.6, Ø40, surface layer PFA coating t =0.03)

Fusing roller (sponge layer t=4, PFA tube t=0.03)

Pressure belt (made of aluminum t=0.6, Ø40, rubber layer t=0.2, PFA tube t=0.03)

Heater of heating roller (halogen heater 1200 W)

A heater was not disposed inside the pressure roller.

In this case, the setting temperature of the heating roller was 200° C.

### (Result)

The heating-up period to 150° C. was 25 sec.

In the paper passing experiment, the recording paper was separated in a direction away from the fusing face.

### Embodiment 5

An experiment was conducted under the following conditions in the structure illustrated in FIG. 2.

### (Structure)

Heating roller (made of aluminum t=0.6, Ø40, surface layer PFA coating t=0.03)

Fusing roller (sponge layer t=4, PFA tube t=0.03)

Pressure belt (made of aluminum t=0.6, Ø40, rubber layer t=0.2, PFA tube t=0.03)

Heater of heating roller (halogen heater 1200 W)

A heater was not disposed inside the pressure roller.

In this case, the setting temperature of the heating roller was 160° C.

### (Result)

The heating-up period to 150° C. was 60 sec.

In the paper passing experiment, the recording paper was separated in a direction away from the fusing face.

### Embodiment 6

### (Structure)

An experiment was conducted under the following conditions in the structure illustrated in FIG. 2.

Heating roller (made of aluminum t=0.6, Ø40, surface layer PFA coating t=0.03)

Fusing roller A (sponge layer t=4, PFA tube t=0.03)

Fusing roller B (rubber layer t=4, PFA tube t=0.03)

Fusing roller C (sponge layer t=3.8, rubber layer t=0.2, PFA tube t=0.03)

Pressure roller (made of aluminum t=0.6, Ø40, rubber layer t=0.2, PFA tube t=0.03)

Heater of heating roller (halogen heater 1200 W)

A heater was not disposed inside the pressure roller.

In this case, the setting temperature of the heating roller was 200° C.

### (Result)

Fusing roller A

The heating-up period was the same as that in Embodiment 4.

Brilliance of blank spots of an image sponge was deteriorated.

The lower limit for fusing was 180° C. or more.

Fusing roller B

The heating-up period to 150° C. was 60 sec.

No uneven brilliance by the releasing of pressure.

The lower limit for fusing was 150° C. or more.

Fusing roller C

The heating-up period to 150° C. was 50 sec.

No uneven brilliance by the releasing of pressure.

The lower limit for fusing was 150° C. or more.

As described above, according to the fuser device according to the present embodiments, the temperature of the fusing member can be increased in a short time, and also the fusing property of the high image quality level can be obtained.

In the fuser device and the image forming device according to the embodiments, the fusing member does not have inside thereof a heat generation source, the surface temperature of the heating member is set higher than the setting temperature of the fusing member, and the diameter of the cylindrical curved surface portion of the fusing member is set to be the diameter of the cylindrical curved surface portion of the cylindrical member of the pressure member or more. Accordingly, the surface of the fusing member can be effectively heated from the heating member and the like, and also the temperature of the fusing member can be increased in a short time without adding a special member in addition to the fusing member, the heating member, and the pressure member. The thickness of the elastic layer of the fusing member is set larger than the thickness of the elastic layer of the pressure member. Therefore, a fusing performance of high image quality level can be obtained.

The fuser device and the image forming device having the fuser device are described in the above embodiments. However, the specific structures are not limited thereto. It should be appreciated that variations may be made in the embodiments described by persons skilled in the art without departing from the scope of the present invention as defined by the following claims.

What is claimed is:

1. A fuser device, comprising:
a fusing member including an elastic layer on a surface side thereof and a cylindrical curved surface portion having a predetermined diameter;
a heating member including a cylindrical curved surface portion having a predetermined diameter, the heating member having contact with the fusing member and heating the fusing member; and
a pressure member including an elastic layer on a surface side thereof and a cylindrical curved surface portion having a predetermined diameter, the pressure member pressing the fusing member, wherein
the fusing member and the pressure member sandwich a recording medium having an unfused toner image so as to fuse the unfused toner image,
a surface temperature of the heating member is set higher than a setting temperature of the fusing member without disposing a heat generation source inside the fusing member,
the diameter of the cylindrical curved surface portion of the fusing member is smaller than a diameter of the cylindrical curved surface portion of the heating member, and
the diameter of the cylindrical curved surface portion of the pressure member is the diameter of the cylindrical curved surface portion of the fusing member or more.

2. The fuser device according to claim 1, wherein the fusing member includes a metallic innermost layer, the elastic layer outside the innermost layer, and a fluorinated protection layer outside the elastic layer.

3. The fuser device according to claim 1, wherein the elastic layer is made of a solid rubber having a heat-resistant property or a sponge having a heat-resistant property.

4. The fuser device according to claim 2, wherein the elastic layer is made of a solid rubber having a heat-resistant property or a sponge having a heat-resistant property.

5. The fuser device according to claim 1, wherein the heating member is made of a metal.

6. The fuser device according to claim 1, wherein the heating member includes on a surface thereof a fluorinated resin layer.

7. The fuser device according to claim 5, wherein the heating member includes on a surface thereof a fluorinated resin layer.

8. The fuser device according to claim 1, wherein the pressure member has inside thereof a heat generation source.

9. The fuser device according to claim 8, wherein the pressure member includes a metallic innermost layer, a rubber layer outside the innermost layer, and a fluorinated protection layer outside the rubber layer.

10. The fuser device according to claim 9, wherein the rubber layer is a solid rubber.

11. The fuser device according to claim 1, wherein the heating member includes a setting temperature in a heating-up period, which is set 10 degrees higher than a setting temperature of the heating member in a standby period.

12. The fuser device according to claim 8, wherein the heating member has setting temperature just before passing the recording medium higher than the setting temperature in the standby period.

13. The fuser device according to claim 8, wherein the pressure member has a setting temperature which is set lower than a setting temperature of the fusing member.

14. The fuser device according to claim 1, wherein the fusing member includes a metallic innermost layer, the elastic layer outside the innermost layer, and a fluorinated protection layer outside the elastic layer, the elastic layer includes a sponge layer and a solid layer outside the sponge layer, and a thickness of the sponge layer is larger than a thickness of a solid rubber layer.

15. The fuser device according to claim 1, wherein the fusing member is a cylindrical fusing roller or an endless fusing belt.

16. The fuser device according to claim 1, wherein the heating member is a cylindrical heating roller or an endless heating belt.

17. The fuser device according to claim 1, wherein the pressure member is a cylindrical pressure roller or an endless pressure belt.

18. The fuser device according to claim 1, wherein the heating member has a heat generation source made of a halogen lamp or a lamp into which noble gas is filled, and the pressure member has a heat generation source made of a halogen lamp or a lamp into which noble gas is filled.

19. An image forming device having the fusing member according to claim 1.
